(19) United States
(12) Patent Application Publication
(10) Pub. No.: US 2019/0010753 A1
(43) Pub. Date: Jan. 10, 2019

(54) RECYCLABLE WEATHERSTRIP SASHES AND FRAMES FOR POLYVINYL CHLORIDE WINDOWS AND DOORS

(71) Applicant: VEKA INC., FOMBELL, PA (US)

(72) Inventor: KEVIN A. SEILING, MONACA, PA (US)

(73) Assignee: VEKA INC., FOMBELL, PA (US)

(21) Appl. No.: 15/642,371

(22) Filed: Jul. 6, 2017

(51) Int. Cl. E06B 7/23; E06B 3/20; C08J 11/06

(52) U.S. Cl. CPC E06B 7/2314; E06B 3/20; E06B 7/2312; C08J 2367/00; C08J 2327/06; C08J 2357/06; C08J 11/06

(57) ABSTRACT

A profile for a sash or frame for windows or doors has a plurality of generally T-shaped elongated weatherstripping receiving recesses, a plurality of elongated weatherstrips secured within the recesses. The weatherstrip has a polyvinyl chloride backer secured to which is acrylic pile and polyester or acrylic fin. A method of reclaiming the profile without previously removing the weatherstrips from the recesses is provided.

### BACKGROUND OF THE INVENTION

### 1. Field of the Invention

The present invention relates to extruded sashes and frames for windows and doors which contain weatherstripping having polyvinyl chloride backing and connected acrylic pile and fins and, more specifically, it relates to such sashes which may be recycled without having to previously separate the weatherstripping from the sash. The sash frames are preferably made from polyvinyl chloride extrusions and may have coextruded over portions of the exterior thereof a polyvinyl chloride layer.

### 2. Description of the Prior Art

It has been known to provide window and door sashes which are secured to weatherstripping such that when the sash is moved to its closed position, the weatherstripping provides an effective seal to resist undesired entry of water, airborne dirt and other foreign matter.

It has also been known to provide such windows and doors having frames made of polyvinyl chloride extrusions.

There has also been known various means of manufacturing structures for functioning in this manner. See, generally, U.S. Pat. No. 4,419,315 and U.S. Pat. No. 6,974,512.

U.S. Pat. No. 8,137,783 discloses a weatherstripping which has polyvinyl chloride backing and various combinations of materials such as polypropylene and polyethylene for use in the pile, fiber yarns and fins. It is stated that the polypropylene would not easily bond to the material of the polyvinyl chloride backing. A synthetic fiber is said to be interlaced with the pile yarns and backing.

One of the serious shortcomings of known systems wherein weatherstripping is made from a large percentage, up to even 100%, polypropylene is that it is not very compatible with polyvinyl chloride extrusions. As a result, when recycling is considered, the weatherstripping must be separately removed from the extrusion of the sash at very substantial cost before the extrusion is reclaimed.

Despite the use of numerous materials in order to achieve the desired sealing action of weatherstripping, there remains the problem of difficulty in reclaiming polyvinyl chloride extrusion sashes containing the weatherstripping due to the hereinbefore stated incompatibility.

### SUMMARY OF THE INVENTION

The present invention has met the hereinbefore described needs in an efficient manner which facilitates economical reclamation of polyvinyl chloride sashes and frames containing weatherstripping.

A sash or frame for a window or door has a plurality of elongated generally T-shape weatherstrip receiving recesses. The weatherstrip receiving openings contain an elongated weatherstrip including a polyvinyl chloride backer, acrylic pile and acrylic fins secured thereto. In a preferred embodiment, the weatherstrip receiving recess is generally rectangular and the weatherstrip backer is also of generally rectangular configuration but of smaller size than the weatherstrip recess within which it is received.

The acrylic materials used in the fin and pile function efficiently to establish the seal while not being required to be removed from the profiles before reclamation.

A method of recycling polyvinyl chloride sashes or frames includes providing polyvinyl chloride sashes having a plurality of elongated weatherstrip receiving recesses and a plurality of elongated weatherstrips having a polyvinyl chloride backer to which is secured acrylic pile and an acrylic fin. The sashes and frames are preferably reduced into pellet form or pulverized by means well known to those skilled in the art, such as mechanical means. The pellet or pulverized scrap from said sash or frame with the weatherstrip in place is heated to the melting point of the sash or frame and weatherstrip, whereby, separation of the weatherstrip from the sash or frame prior to reclamation is eliminated. Heating is preferably effected at least 350° F. and, most preferably, at about 350° F. to 450° F.

It is an object of the present invention to provide a polyvinyl chloride sash with effective weatherproofing which combination facilitates ready recycling of the sash without requiring or making desirable prior separation of the weatherstrip from the sash.

It is another object of the present invention to provide a profile for windows or doors which, through choice of compatible materials, provides effective sealing action while facilitating economical reclamation of the profile of the sash or frame.

It is another object of the present invention to provide a profile with a plurality of elongated generally rectangular weatherstrip receiving recesses which have a generally rectangular backer composed of polyvinyl chloride and pile and fins composed of acrylic material.

It is a further object of the present invention to facilitate reclamation of weatherstrip material from extruded scrap and saw cuts during manufacture of profiles for sashes and frames for windows and doors.

It is yet another object of the present invention to provide a method of reclaiming polyvinyl chloride sashes and frames in an economical and time efficient manner.

These and other objects of the invention will be more fully understood from the following description of the invention on reference to the illustrations appended hereto.

### BRIEF DESCRIPTION OF THE DRAWINGS

FIG. 1 is a cross-sectional view of a portion of a sash having two weatherstrip elements secured within recesses in the sash.

FIG. 2 is a front elevational view of a weatherstrip element of the present invention.

FIG. 3 is a top plan view of the weatherstrip of FIG. 2.

FIG. 4 is a bottom plan view of the weatherstrip of FIG. 2.

FIG. 5 is a right elevational view of the weatherstrip of FIG. 2.

FIG. 6 is a left elevational view of the weatherstrip of FIG. 2.

FIG. 7 is a cross-sectional view of a sash containing weatherstrips disposed in sealing contact with a window frame.

### DESCRIPTION OF THE PREFERRED EMBODIMENTS

As employed herein, the term “profile” will refer to a portion of a window or door which is structured to be moveable with respect to a portion of a sash or frame of the window or door.

As employed herein, the term “sash” will refer to a sash for a window or door or a sash element structured to be a portion of the same.

As employed herein, the term “frame” will refer to a frame for a window or door or a frame element structured to be a portion of the same.

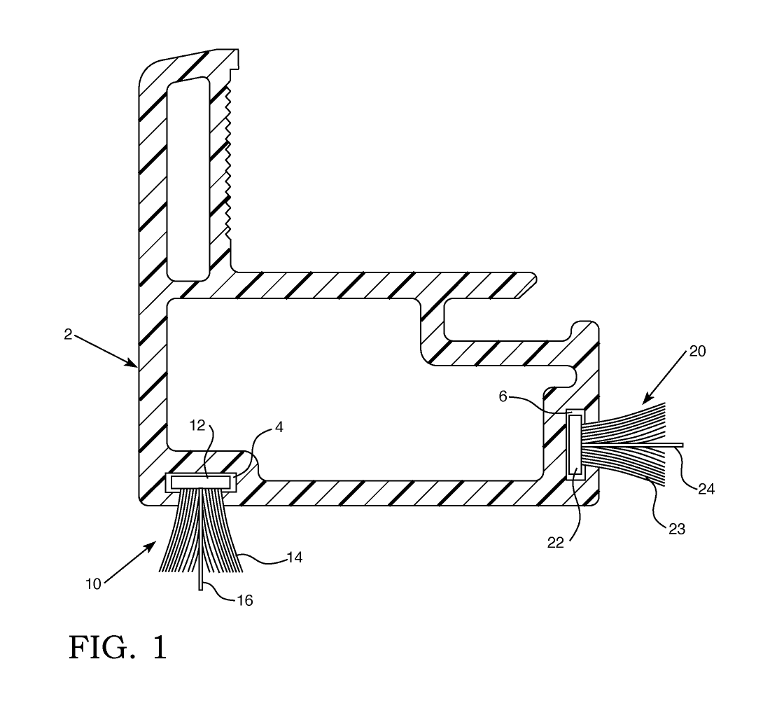

Referring to FIG. 1, there is shown a cross-sectional view illustrating the profile of a polyvinyl chloride sash frame 2. The frame 2 has a pair of elongated weatherstrip receiving recesses 4 and 6. The recesses 4,6 are generally a rectangular configuration.

Weatherstrip element 10 has an elongated generally rectangular backer 12 received within recess 4 and is generally coextensive therewith.

Weatherstrip 10 has a pile 14 which is secured to backer 12 and extends out of recess 4 and is structured to be compressed against the frame which receives the sash 2.

Elongated weatherstrip 10 also has a projecting fin 16 which is secured to backer 12, projects outwardly from the recess and, in the form shown, protects farther than the free ends of the pile 14. The backer 12 is made of polyvinyl chloride and the pile 14 is acrylic and fin 16 is acrylic or polyester, such as a material sold under the trade designation “Mylar”.

Similarly, elongated weatherstrip 20 is disposed within recess 6 and has a polyvinyl chloride backer 22 which is of generally rectangular configuration but of lesser dimension than rectangular recess 6.

Weatherstrip 20 also has an acrylic pile 23 and an polyester fin 24 secured to backer 22.

The positioning and dimensions of the weatherstrip 10 and 20 are such that when the sash is in closed position, sealing will be effected against the adjacent window or door frame.

The weatherstrips 10,20 are inserted into the extruded frame 2 during the continuous extrusion process, after which the extrusion is cut to the desired length. The sash may then be fusion welded, glazed and then installed in the window frame.

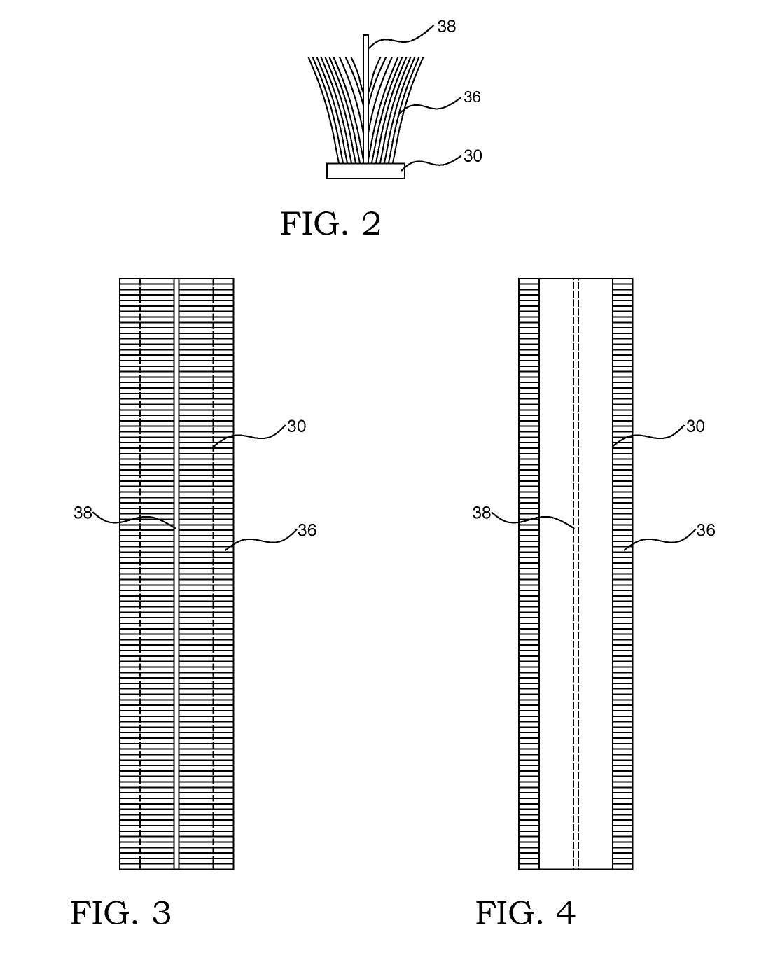

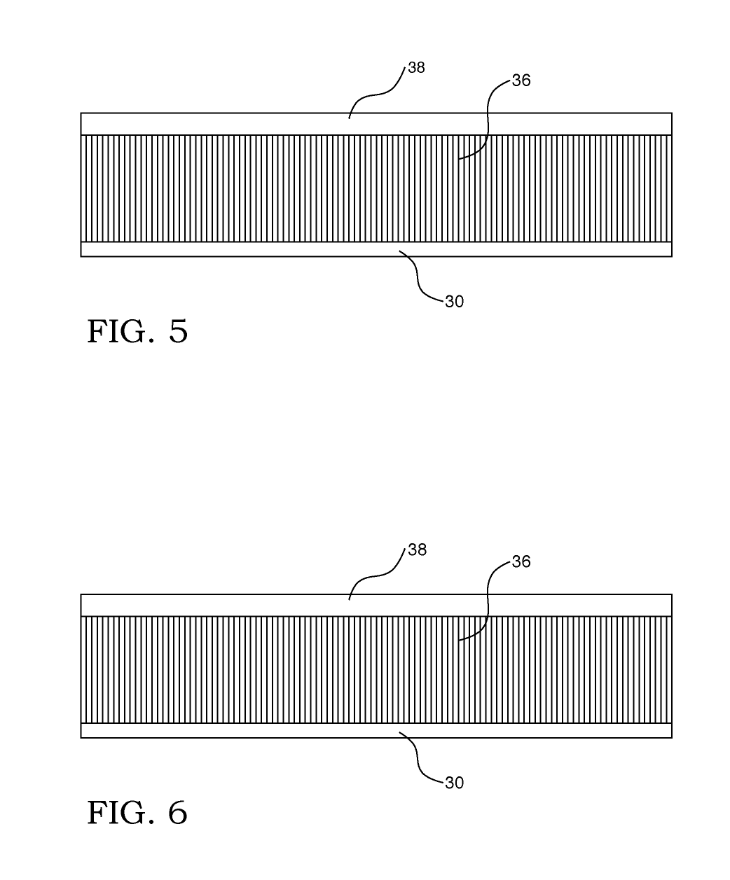

Considering FIGS. 2 through 6, general details of the preferred weatherstrip of the present invention will be provided. The weatherstrip has a backer 30. Secured thereto and projecting upwardly therefrom are the acrylic pile 36 and the fin 38. The projecting fin 38 is structured to be compressed for additional sealing action.

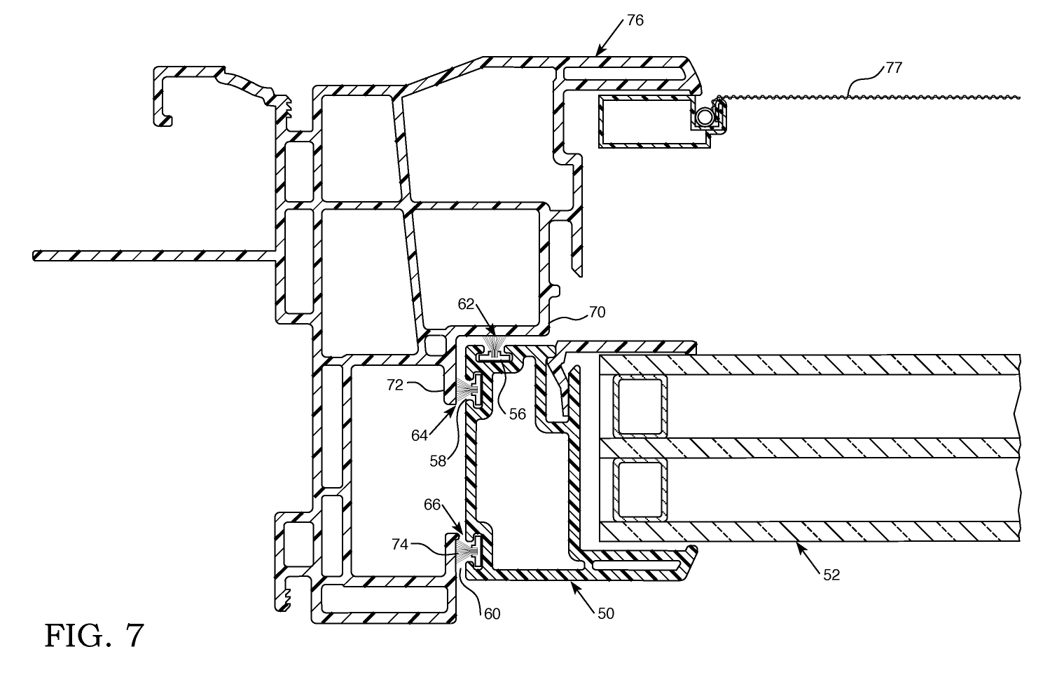

Referring to FIG. 7 there is shown a cross-sectional view of polyvinyl chloride sash 50 having glazing 52 and three elongated weatherstrip receiving recesses 56, 58, and 60 within which are disposed in weatherstrips 62,64 and 66, respectively. The weatherstrips 62, 64, and 66 are in sealing contact with portions 70, 72, and 74 respectively of frame 76. A screen 77 is shown secured to frame 76.

It will be appreciated that the choice of the polyvinyl chloride backer in combination with the acrylic pile and polyester or acrylic fin solve a major problem in respect of reclamation of weatherstrip in this environment. The problem with respect to polypropylene's incompatibility with polyvinyl chloride is eliminated. This results in avoidance of the need to separately remove the weatherstrip elements, such as 10 and 20, prior to reclaiming the sash.

The method of reclamation of the present invention involves providing the disclosed weatherstrip having a polyvinyl chloride backer and acrylic pile and polyester fin secured thereto. During manufacture of sashes and frames for windows and doors from elongated extruded polyvinyl chloride profiles which receive elongated weatherstripping, the workpiece is cut transversely to the desired length for specific product being made. The ends of the severed workpiece are then cut to the desired shape, such as, for example, four pieces for provided four mitered corners in the sash or frame. This process creates a meaningful amount of scrap which, if recycled, would be of commercial value. Reclamation of the profile of the sash or frame is achieved without requiring prior removal of the weatherstrip therefrom. The extruded scrap, saw cuts and other recyclable components are subjected to mechanical reduction in size as by creating pellet size portions or pulverizing the same. The mechanically reduced scrap is then heated to a temperature of at least the melting points of the polyvinyl chloride and the weatherstrip. This temperature will generally be at least 350° F. and, preferably, be in the range of about 350° F. to 450° F. After this has been accomplished, the materials from the entire sash have been reclaimed in an economical and effective manner and may be reused.

Whereas, particular embodiments of the invention have been described herein for purposes of illustration, it will be evident to those skilled in the art that numerous variations of the details may be made without departing from the invention as defined in the appended claims.

What is claimed is:

1. A polyvinyl chloride profile for a sash or frame for a window or door comprising,
a polyvinyl chloride profile having a plurality of elongated generally T-shaped weatherstrip receiving recesses,
a plurality of elongated weatherstrips,
said elongated weatherstrips received within said recesses,
each said weatherstrip having a polyvinyl chloride backer,
acrylic pile secured to said backer, and
a fin composed of at least one material selected from the group consisting of polyester and acrylic secured to said backer.

2. The polyvinyl chloride profile of claim 1 including,
said weatherstrip receiving recesses being generally rectangular in cross-section, and
said weatherstrip backer being generally rectangular in shape but of smaller size than the recess within which it is disposed.

3. The polyvinyl chloride profile of claim 2 including,
said weatherstrip pile extending from said backer out of said weatherstrip receiving recess to facilitate sealing engagement with a window frame or door frame.

4. The polyvinyl chloride profile of claim 3 including,
said fin secured to said backer and extending out of said weatherstrip receiving recess.

5. The polyvinyl chloride profile of claim 4 including,
said pile and said fin extending in generally the same direction with said fin extending farther from said backer than said pile.

6. The polyvinyl chloride profile of claim 1 including,
said sash being structured to be in sliding engagement with respect to the portion of the door or window frame with which it is engaged.

7. A weatherstrip for use with a polyvinyl chloride profile for a sash or frame for a window or door comprising,
an elongated polyvinyl chloride backer having a generally rectangular cross-section,
acrylic pile secured to said backer, and
an acrylic fin secured to said backer and extending in generally the same direction as said pile.

8. The weatherstrip of claim 7 including,
said backer being elongated and generally coextensive with said pile and said fin.

9. The weatherstrip of claim 7 including,
said backer structured to be received within a recess in a sash frame.

10. The weatherstrip of claim 8 including,
said fin being generally centrally secured to said backer with respect to said pile.

11. A method of recycling weatherstrip from polyvinyl chloride profiles for a sash or frame for a window or door comprising,
providing said polyvinyl chloride profile having a plurality of elongated weatherstrip receiving recesses,
providing a plurality of elongated weatherstrips within said recesses,
said recesses being of generally rectangular configuration,
said weatherstrips having polyvinyl chloride backers which are generally rectangular in configuration secured within said recesses,
said weatherstrips having fins composed of at least one material selected from the group consisting of polyester and acrylic secured to said backers and extending out of said recesses,
subjecting said profiles to mechanical size reduction, and
subjecting said mechanically reduced profiles to an elevated temperature to melt said mechanically reduced profiles, whereby reclamation is effected without requiring prior separation of said weatherstrip from said sash.

12. The method of claim 11 including,
said weatherstrips receiving recesses and said weatherstrips both being substantially continuous.

13. The method of claim 11 including,
effecting said melting at a temperature of about 350° F. to 450° F.

14. The method of claim 11 including,
providing said sash or frame as an element structured to be a portion of a sash or frame.

15. The method of claim 14 including,
assembling a plurality of said elements to create said sash or frame.
